(19) United States
(12) Patent Application Publication
(10) Pub. No.: US 2006/0168071 A1
(43) Pub. Date: Jul. 27, 2006

(54) Electronic mail sending and receiving system

(76) Inventor: Takayuki Sugiura, Tokyo (JP)

Correspondence Address: KATTEN MUCHIN ROSENMAN LLP, 575 MADISON AVENUE, NEW YORK, NY, 10022-2585, US

(21) Appl. No.: 11/320,327

(22) Filed: Dec. 28, 2005

Related U.S. Application Data
(63) Continuation of application No. PCT/JP03/08325, filed on Jun. 30, 2003.

(51) Int. Cl. G06F 15/16

(52) U.S. Cl. 709/206

(57) ABSTRACT

There is provided an electronic mail sending and receiving system capable of encrypting an electronic mail including its header when sending it without installing an encryption system in a sender client and decrypting the electronic including its header mail when received without installing an encryption system in a receiver client. A sender's mail server includes an SMTP server for receiving a plaintext electronic mail sent from a sender client, destination check means for checking an electronic mail destination, and electronic mail encrypting and sending means for encrypting the electronic mail by using an SMTP/S protocol if the destination check result shows that the electronic mail delivery destination supports the SMTP/S protocol when sending the mail. A receiver's mail server includes an SMTP server for receiving an electronic mail and mail decryption/reception means for decoding the electronic mail received.

### CROSS-REFERENCE TO RELATED APPLICATION

This application is a continuation of International Application PCT/JP03/08325 filed on Jun. 30, 2003, pending, the contents of which are herein wholly incorporated by reference.

### TECHNICAL FIELD

The present invention relates to a system and a method for ensuring mail security of electronic mail and a recording medium on which the program therefore is recorded.

### RELATED ART

In recent years, electronic mails are widely used for private use and for business or commercial transaction. Accordingly, security measures become more important. As systems for security measures such as secrecy of electronic mails, encryption programs such as S/MIME (Secure/Multipurpose Internet Mail Extension) of sending encrypted messages in a MIME manner and PGP (Pretty Good Privacy), or mail clients having a security function of encrypting contents of the electronic mails by the use of the receiver's public key when sending the electronic mails are widely used.

In order to allow the security measures to effectively function, a method of introducing in advance in a client terminal individually the receiver's public key or the sender's digital certificate is generally employed.

However, in such conventional systems, it is necessary to install a security system for encryption or the like in sender client, in sender's mail server, in receiver's client, and in receiver's mail server which are used to send and receive electronic mails.

In order to simply introduce and spread the security measures, a system, which is able to encrypt an electronic mail including its header part when sending it without installing an encryption system in sender client and which is able to decrypt the electronic mail including its header part when receiving it without installing a decryption system in receiver's client is required.

For example, in “Electronic Mail System and Electronic Mail Communication Method” disclosed in JP-A-2002-342239, in which the sender can check existence of erroneous delivery of an electronic mail and leakage of mail contents can be prevented, even when the erroneous delivery occurs, has been suggested.

The sender's terminal encrypts and sends an electronic mail and requests registration to an encryption management server along with decryption information. When receiving the encrypted electronic mail, the receiver's terminal acquires the decryption information registered in the encryption management server, and decrypts the encrypted electronic mail, and sends data indicating that the electronic mail has been confirmed already to the encryption management server. The sender's terminal accesses the encryption management server to check whether the data indicating that the receiver's terminal has confirmed already is registered. As a result, it is possible for the sender to check the erroneous delivery of electronic mail and thus the leakage of the contents of the electronic mail can be prevented even when the erroneous delivery occurs.

However, the above-mentioned system is designed to accomplish an object of preventing the leakage of the contents of the electronic mail even when the erroneous delivery of the electronic mail occurs. Accordingly, it is still necessary to install a security system for encryption in advance in sender client,.in sender's mail server, in receiver's client, and in receiver's mail server, which are used to send and receive the electronic mails.

Further, in “Secure Mail Proxy System and Method and Recording Medium” disclosed in JP-A-2002-24147, a system capable of ensuring security of an electronic mail in Internet without depending on existence of a security function in a client terminal has been suggested.

Here, a proxy is disposed between a mail server in a LAN (Local Area Network) and Internet. The mail server receiving a plaintext mail from a mail client sends to the proxy a mail toward the outside of the LAN with a plaintext status.

Then, the proxy encrypts the plaintext mail, adds a signature of sender to the encrypted mail, and sends out the signed encrypted mail to the Internet. The proxy checks existence of correction of the signed encrypted mail from the Internet, decrypts and sends the encrypted mail to the mail server with a plaintext status when the mail is not corrected, and rejects the reception of the mail when the mail is corrected, thereby preventing the corrected mail from entering the LAN.

Since a proxy device is inserted to act for the encryption and the addition of signature of the electronic mail sent to the Internet, and the decryption of the signature encrypted mail is disposed between the mail server in the LAN and the Internet, the security measures could be taken without depending upon the existence of the security function on the mail server, the mail client, or the user terminal.

However, since the proxy device essentially employs the system for encrypting the plaintext mail, adding the signature of the sender to the encrypted mail, and sending out the signed encrypted mail to the Internet, the above-mentioned system has the following problems. That is, it is still necessary to install a system in advance for decrypting the electronic mail in the receiver's terminal by the use of the above-mentioned system. When the destination of the electronic mail does not correspond to the decryption of the system or when the check result for correspondence is not clear, the security system does not function as intended. Accordingly, it is not clear whether the received electronic mail could be decrypted in the destination.

In addition, in “Electronic Mail System with Security Function” disclosed in JP-A-2002-9815, there has been suggested an electronic mail system capable of sending and receiving an encrypted electronic mail between a sender's mail server and a receiver's mail server even when client terminals do not have encryption or decryption means in an electronic mail system.

The electronic mail system includes a plurality of electronic mail clients, an electronic mail server having a plurality of encryption functions, an electronic mail server having a plurality of decryption functions, and a network. The electronic mail server having the encryption functions acquire an encryption method of the electronic mail which can be decrypted by the electronic mail server having the decryption functions, encrypts the electronic mail by the use of the acquired encryption method, and sends the encrypted electronic mail to the electronic mail server having the decryption functions. Then, the electronic mail server having the decryption function decrypts the received electronic mail.

However, in the above-mentioned system, it is still necessary to install the electronic mail decrypting system in advance in the receiver side. When the destination of the electronic mail does support the decryption in that system or when it is not clear whether the destination of the electronic mail support, the security system does not function as intended. Accordingly, it is not clear whether the received electronic mail could be decrypted in the destination. In addition, at the time of encryption in that system, in order to support the electronic mail server of destination, having a plurality of decryption functions, the electronic mail server having the encryption function acquires the encryption method of the electronic mail which can be decrypted by the electronic mail server having the decryption function and encrypts the electronic mail. Accordingly, the processes in the program are complicated and the encryption method should be acquired from the network.

In addition, in “Encrypted Mail Transmitting and Receiving System” disclosed in JP-A-2001-257710, there has been suggested system extension means for sending and receiving an encrypted mail under the minimum reconstruction of existing systems, among a plurality of mail systems having different protocols.

In the terminal having mail sending and receiving means, encryption/decryption means and encryption/decryption processing means with protocol conversion means, the mail server having mail transmission/storage means, and the encrypted electronic mail sending and receiving system with a gateway including the protocol conversion means, when sending an encrypted electronic mail, this system analyzes its destination and determines the receiver's protocol, and the terminal encrypts electronic mails and converts protocols. At the time of decrypting the received encrypted mail, the system analyzes the format of the encrypted mail to determine the sender's protocol and the terminal decrypts the encrypted mail and converts the protocol.

In the above-mentioned technology, in order to send and receive an encrypted mail among a plurality of mail systems having different protocols, the gateway having the protocol conversion means is provided. The gateway analyzes a mail destination to determine a protocol of the destination. However, in order to allow the terminal to perform the encryption and the protocol conversion of the mail, it is necessary to install in advance a security system for encryption or the like in the each terminal.

In addition, in “Encryption System and Recording Medium” disclosed in JP-A-2000-183951, there has been suggested an encryption system in which an electronic mail is encrypted and sent by a gateway and is decrypted by a receiver.

A table in which domain names and destinations of encryption targets are registered in advance and means for encrypting a content of an electronic mail when an electronic mail is sent and the destination of the electronic mail is registered in the table, converting the domain name of the destination of the electronic mail into the domain name registered in the table, and sending the electronic mail are provided in a sender gateway. In addition, a table in which domain names are registered in advance and means for decrypting an electronic mail when the electronic mail is received and encrypted, converting the domain name of a delivery source of the electronic mail into the domain name registered in the table, and sending the electronic mail to the destination are provided in a receiver gateway.

In the above-mentioned technology, when the destination of the electronic mail is registered in the table, the content of the electronic mail is encrypted and even when the destination does not cope with the decryption, the technology can be used. However, when the destination copes with the decryption, it is necessary to install a security system for encryption or the like in advance in a terminal in order to allow the terminal to perform the encryption and the protocol conversion of an electronic mail. In addition, at the time of delivery and reception of an electronic mail, the process of converting the domain name into the domain name registered in the table should be performed. Further, there is a disadvantage that existence of encryption should be registered in the table to correspond to the destination and any change should be registered in the table.

Means for Solving the Problems

The present invention is contrived to solve the above-mentioned problems. An object of the present invention is to provide a system capable of, in order to simply introduce and distribute security measures, encrypting an electronic mail including its header when sending the electronic mail without installing an encryption system in sender clients and decrypting the electronic mail including its header when receiving the electronic mail without installing an encryption system in receiver clients.

Another object of the present invention is to provide a system capable of functioning even when a destination of electronic mail does not support the decryption of this system or even when it is not clear whether the destination of electronic supports that decryption and of checking whether the destination supports an encrypted electronic mail. In addition, another object of the present invention is to provide a system not requiring an encryption method and not converting the domain name when sending an electronic mail and to provide the simple system without the maintenance in the table to manage destinations, and to provide hardware having all functions, therefore it is able to construct this system by only putting that hardware.

In order to accomplish the above-mentioned objects, according to a first aspect of the present invention, there is provided an electronic mail sending and receiving system which is able to encrypt an electronic mail including its header when sending it without installing individually an encryption system in the sender's terminal and to decrypt the electronic mail including its header when receiving it without installing individually a decryption system in the receiver's terminal, composing sender clients, the sender's mail server, receiver clients, the receiver's mail server, and the networking between the sender clients and the receiver clients, wherein the sender's mail server includes: an SMTP server for receiving a plaintext electronic mail sent from the sender's terminal; destination check means in the electronic mail; as a result of them, this system calls an SMTP/S protocol for encrypting and sending an electronic mail including its header when the destination of the electronic mail supports the SMTP/S protocol, and wherein the receiver's mail server includes: an SMTP server for receiving the electronic mail sent from the sender server and decryption means to decrypt the received electronic mail.

In order to accomplish the above-mentioned objects, according to a second aspect of the present invention, there is provided an electronic mail sending and receiving system which is able to encrypt an electronic mail including its header when sending it without installing individually an encryption system in the sender's terminal composing sender clients and the sender's mail server, the system further comprising: destination check means in the electronic mail; as a result of them, this system call an SMTP/S protocol for encrypting and sending an electronic mail including its header when the destination of the electronic mail supports the SMTP/S protocol.

In order to accomplish the above-mentioned objects, according to a third aspect of the present invention, in the electronic mail sending and receiving system according to the first or second aspect, the destination check means of the sender's mail server means a filtering server having a function of determining whether the receiver's mail server corresponds to the SMTP/S protocol.

In order to accomplish the above-mentioned objects, according to a fourth aspect of the present invention, in the electronic mail sending and receiving system according to the third aspect, the determination of correspondence to the SMTP/S protocol results whether a handshake to an SMTP/S protocol port in the receiver's mail server is possible and includes whether the domain name in the receiver's mail server is ensured by an authentication center.

In order to accomplish the above-mentioned objects, according to a fifth aspect of the present invention, in the electronic mail sending and receiving system according to any one of the first to fourth aspects, the electronic mail encrypting and sending means in the sender's mail server sends, as a result of the destination check, a plaintext mail by the use of the SMTP protocol when the receiver's mail server does not support the SMTP/S protocol.

In order to accomplish the above-mentioned objects, according to a sixth aspect of the present invention, in the electronic mail sending and receiving system according to any one of the first to fifth aspects, the SMTP server in the receiver's mail server stores the electronic mails sent by client in each receiver's mail box, when the destination of the electronic mail is in a local area.

In order to accomplish the above-mentioned objects, according to a seventh aspect of the present invention, in the electronic mail sending and receiving system according to any one of the first to sixth aspects, the SMTP server in the receiver's mail server is able to encrypt the path between the receiver's mail server and the receiver's mail client by receiving the electronic mails stored in the each mail box by the use of POP3/S and IMAP/S protocols.

In order to accomplish the above-mentioned objects, according to an eighth aspect of the present invention, in the electronic mail sending and receiving system according to any one of the first to seventh aspects, when the receiver's mail server transmits the electronic mail to another mail server, the receiver's mail server includes: destination check means in the electronic mail, which determine whether the destination supports the SMTP/S protocol or not and electronic mail encrypting and sending means as a result of the destination check. When the destination supports the SMTP/S protocol, the electronic mails are encrypted and sent by it and when the destination does not support the SMTP/S protocol, the electronic mails are sent in plaintext by the SMTP protocol.

In order to accomplish the above-mentioned objects, according to a ninth aspect of the present invention, in the electronic mail sending and receiving system according to any one of the first to eighth aspects, the mail encrypting and sending means in the sender's mail server returns to the sender client the electronic mail indicating that the process is not successful including that data, when the electronic mail encryption by the use of the SMTP/S protocol is failed.

In order to accomplish the above-mentioned objects, according to a tenth aspect of the present invention, in the electronic mail sending and receiving system according to any one of the first to ninth aspects, the mail encrypting and sending means in the sender's mail server has a function of analyzing the data of the encryption process in the electronic mail header sent by the sender client.

### BRIEF DESCRIPTION OF THE DRAWINGS

FIG. 1 is an example of the construction in this entire system.

FIG. 2 is an example constructing the SNTP server and the electronic mail encrypting system in the same hardware.

FIG. 3 is an example constructing the SNTP server and the electronic mail encrypting system in different hardware.

FIG. 4 is an example of the electronic mail encrypting system construction with filtering server.

FIG. 5 is an example of the system construction available to search and read the information recorded in the sent and received database.

FIG. 6 is an example of the system construction available to search and read the information recorded in the sent and received database.

FIG. 7 is the construction of the hardware completed the mail encryption system in the present invention.

FIG. 8 is a flow of processes using the system in the present invention.

FIG. 9 is a flowchart of the basic processes in sender side.

FIG. 10 is a flowchart of the basic processes in receiver side.

### BEST MODE FOR CARRYING OUT THE INVENTION

Hereinafter, the systems of the present invention will be described with reference to the accompanying figures.

An electronic mail sending and receiving system according to the present invention includes sender clients and a sender's mail server, receiver clients and a receiver's mail server, and the networking between the sender clients and the receiver clients.

In the electronic mail sending and receiving system according to the present invention, it is the system which is able to encrypt an electronic mail including its header when sending it without installing individually an encryption system in the sender's terminal and to decrypt the electronic mail including its header when receiving it without installing individually a decryption system in the receiver's terminal.

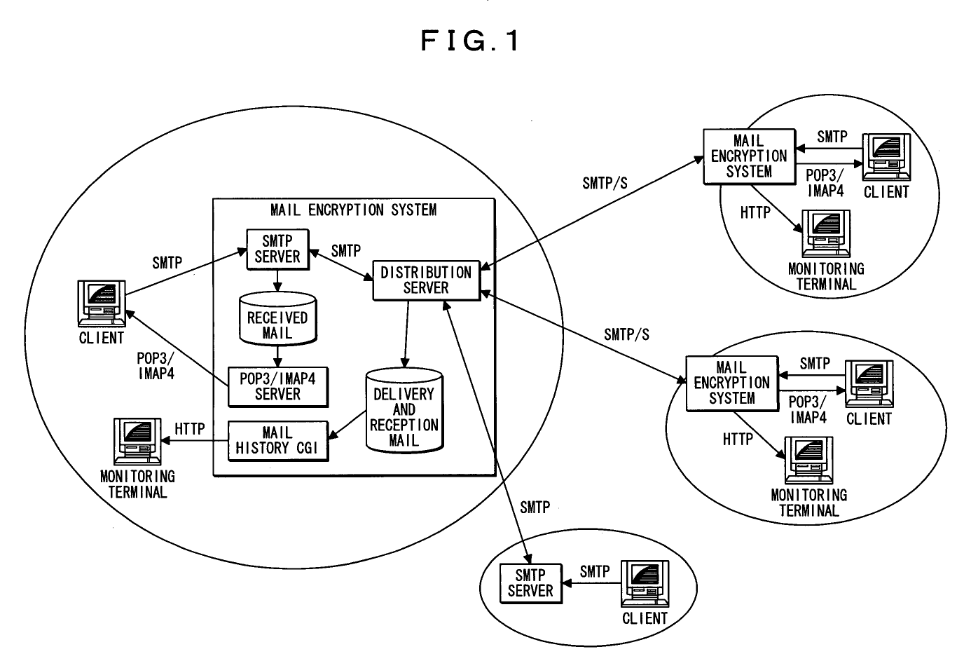

FIG. 1 is an example of the entire system construction, in each system, which is able to encrypt an electronic mail including its header when sending it without installing individually an encryption system in the sender's terminal and to decrypt the electronic mail including its header when receiving it without installing individually a decryption system in the receiver's terminal.

In the following description and the accompanying figures, the mail server implementing the above-mentioned functions is expressed as a “mail encryption system” as needed.

In the following description and the accompanying figures, the encrypted SMTP protocol, which is used to send the electronic mail including the header without installing an encryption system in the sender client and to receive it without installing a decryption system in the receiver client will be call “SMTP/S protocol” for the purpose of convenience as needed.

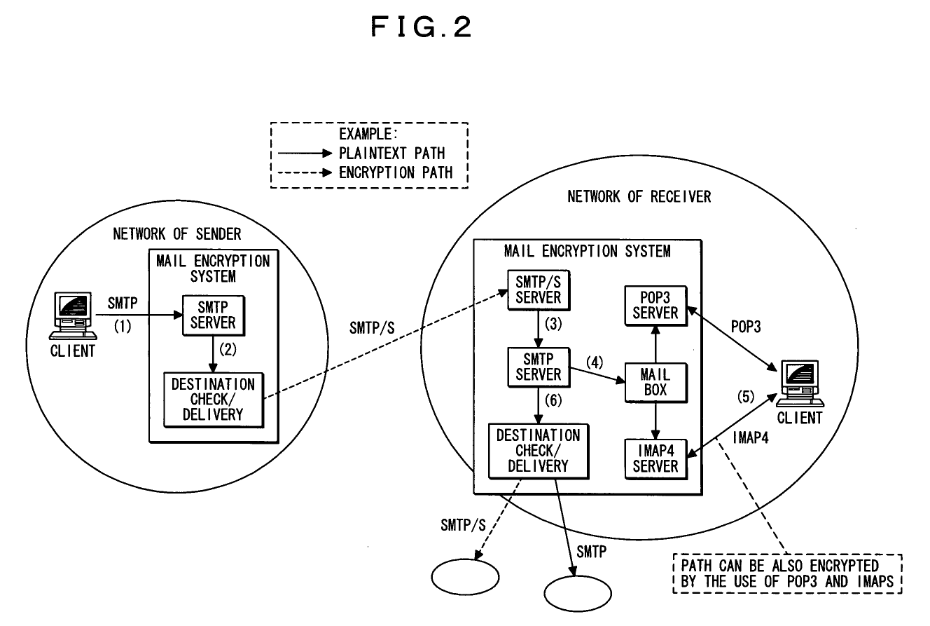

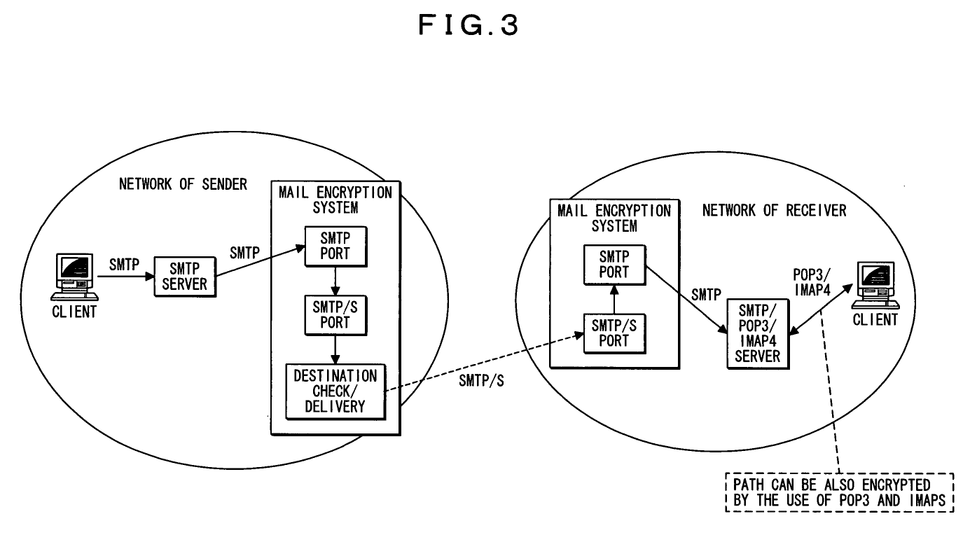

Next, referring to FIGS. 2 and 3, an example of the each construction of the sender clients and the sender's mail server, and the receiver client and the receiver's mail server is described.

FIGS. 2 and 3 are exemplary illustration of the system construction according to the present invention. An example that the SMTP server and the electronic mail encryption system are constructed in the same hardware is shown in FIG. 2 and an example that the SMTP server and the mail encryption system are constructed by individual hardware is shown in FIG. 3.

First, the sender's mail server will be described.

The sender's mail server includes an SMTP server for receiving a plaintext electronic mail sent from the sender client.

The SMTP server is a server supported the SMTP protocol to send electronic mails. The SMTP server receives the electronic mail sent from the client. In generally known an electronic mail sending and receiving system, the SMTP server operating in the network of a destination user is searched for and the sender's SMTP server transmit the electronic mail to the receiver's SMTP server. In order for the destination user to receive the electronic mail, a POP3 server or an IMAP4 server operating in the SMTP server is called and the electronic mail received in the receiver's SMTP server is transmitted.

On the contrary, in the electronic mail sending and receiving system according to the present invention, a client sends an electronic mail to an SMTP server in a mail encryption system of own network and the SMTP server in the mail encryption system receives a plaintext electronic mail (arrow (1) in FIG. 2). The plaintext electronic mail may be in the form of text, HTML, or the like.

Next, the sender's mail server includes destination check means in the electronic mail. Accordingly, it is determined whether the destination supports the SMTP/S protocol or not (arrow (2) in FIG. 2).

The destination check means in the sender's mail server is a filtering server having a function of determining whether the receiver's mail server copes with the SMTP/S protocol.

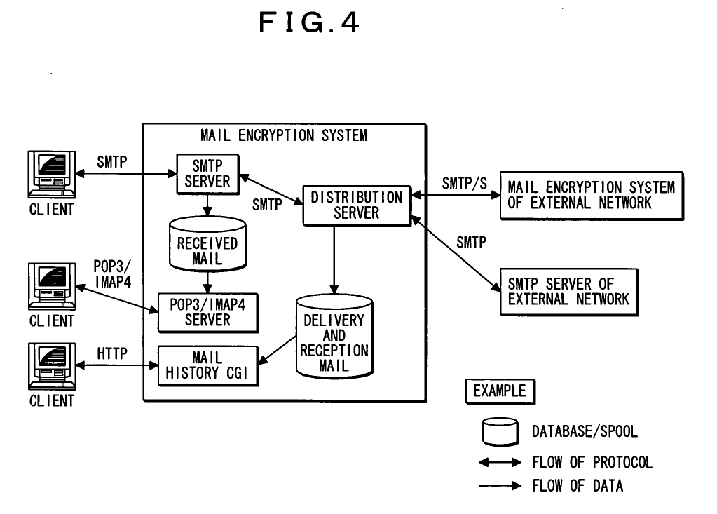

FIG. 4 is an exemplary illustration of the mail encryption system with the filtering server.

The filtering server encrypts and transmits electronic mails in the mail encryption system. When the destination of the electronic mail supports the mail encryption system, the electronic mail is automatically encrypted. When the destination does support the mail encryption system, the electronic mail is sent to the destination by the use of the general SMTP protocol.

In FIG. 4, the database of sending and receiving data records the electronic mail sent from the mail encryption system or the electronic mail received through the mail encryption system.

According to an exemplary illustration, through a process of a CGI program or the like referring to a history of the electronic mail, the information recorded in the database of sending and receiving data can be searched and read.

The filtering server extracts a destination with reference to a header of the electronic mail received from the SMTP server and determines whether the receiver's mail server supports the SMTP/S protocol.

At the time of determining whether it supports the SMTP/S protocol, since the sender's and receiver's SMTP/S servers are reliable, it is preferable that the determination includes, by the use of a system of an authentication center, whether a handshake with an SMTP/S protocol port of the receiver's mail server is possible and whether the domain name in the receiver's mail server is authenticated by the authentication center.

At the time of sending the electronic mail, it is necessary to support the SMTP/S protocol in the receiver side. It is determined from the following two conditions.

1. The handshake with the receiver's SMTP/S protocol port is possible.

2. The domain name in the receiver side is authenticated by the authentication center.

For the destinations (To/Cc/Bcc) included in the electronic mail, the SMTP server accesses to the filtering server with the SMTP protocol and the filtering server analyzes the SMTP protocol and researches the destination network of the electronic mail trying to sent, thereby determining whether the mail encryption system according to the present invention exists and determining whether the authentication is successful.

Next, as a result of the destination check in the electronic mail, the sender's mail server includes electronic mail encrypting and sending means in the electronic mail by the use of the SMTP/S protocol when the destination of the electronic mail supports the SMTP/S protocol.

When the destination supports the SMTP/S protocol, the electronic mail encrypting and sending means encrypts and sends the electronic mail by the use of the SMTP/S protocol (arrow (2) in FIG. 2). As a result of the destination check in the electronic mail, the destination of the electronic mail does not support the SMTP/S protocol, the electronic mail encrypting and sending means sends the electronic mail by the use of the SMTP protocol.

When a path of the SMTP/S protocol is established once, a user expects to encrypt the electronic mail with respect to the same path. Accordingly, it is necessary following process when the electronic mail could not be encrypted and an example of such a process can include the following method.

1. When the electronic mail could not be encrypted, an electronic mail meaning “Failed because it could not be encrypted” is returned to the sender.

When the process of encrypting and sending an electronic mail by the use of the SMTP/S protocol could be failed, the electronic mail encrypting and sending means in the sender's mail server returns to the sender client the electronic mail indicating that the process is failed.

2. By adding a mail header predetermined in the extension form to the electronic mail, it is possible to support the electronic mail, which should be necessarily encrypted and sent. The electronic mail without a predetermined mail header in the extension form is sent as a plaintext mail when it could not be encrypted.

The electronic mail encrypting and sending means in the sender's mail server has a function analyzing data indicating that an encryption process included in the header of the electronic mail received from the sender client is essential and thus determined whether the electronic mail should be necessarily encrypted for delivery.

Next, the receiver's mail server will be described.

The receiver's mail server includes the SMTP server to receive an electronic mail.

The receiver's mail server includes mail decrypting and receiving means in the received electronic mail.

The SMTP server of the receiver's mail server stores the electronic mails sent from the sender client in each mailbox when the destinations in the electronic mails are in a local area.

The server received the electronic mail encrypted by the use of the SMTP/S protocol decrypts the electronic mail and transmits it to the SMTP server (arrow (3) in FIG. 2). The SMTP server stores the electronic mail in each mailbox when the destination is in a local area (arrow (4) in FIG. 2). Then, the SMTP server processes the request of the POP3 or IMAP4 protocol.

The SMTP server of the receiver's mail server can encrypt the path between the receiver's mail server and the receiver clients to receive the electronic mail stored in the each mailbox client by the use of the POP3/S or IMAP/S protocol.

When the receiver's mail server transmits the electronic mails to another mail server, the receiver's mail server includes destination check means in the electronic mail, and as a result of them the receiver's mail server encrypts and transmits electronic mails by the use of the SMTP/S protocol when the destination of the electronic mail supports it.

In case of delivery to another server (transfer etc.), the electronic mail is sent to the SMTP server and the SMTP server in the mail encryption system receives a plaintext electronic mail and determines whether a destination supports the SMTP/S protocol.

As a result of the destination check, the electronic mail is sent by the use of the SMTP protocol or the SMTP/S protocol.

The mail server in the mail encryption system checks the destination of the electronic mail and encrypts and sends the electronic mail by the use of the SMTP/S protocol when the destination supports the SMTP/S protocol (arrow (6) in FIG. 2).

As described above with reference to FIG. 4, the electronic mail sent from the mail encryption system or the electronic mail received through the mail encryption system is recorded in the sending and receiving database. According to an exemplary illustration, the receiver's mail server can be allowed to search and read the information recorded in the sending and receiving database through the use of the CGI program or the like referring to the history of the electronic mails.

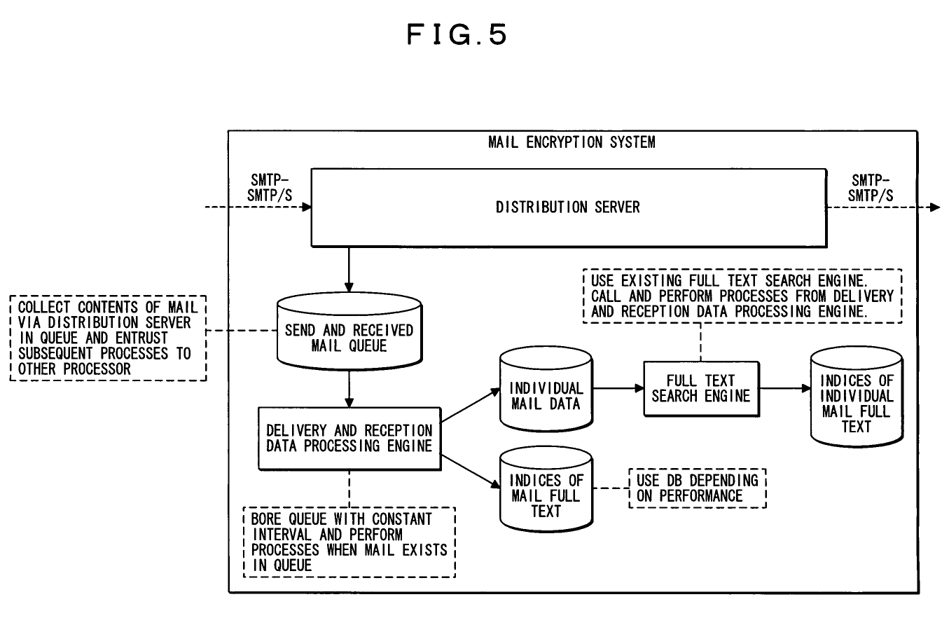

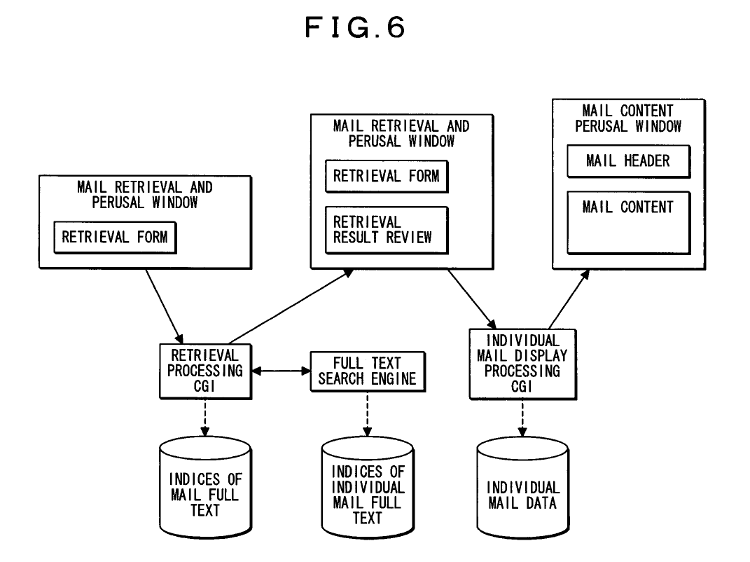

FIGS. 5 and 6 show examples of the system construction in which the information recorded in the sending and receiving database can be searched and be read.

Referring to FIG. 6, through the use of the CGI program or the like referring to the history of electronic mails, in the electronic mail index search, the parts other than the mail content are searched from the data in the whole electronic mail index including its header by searching process of the CGI or the like, and the mail content is searched from the individual whole electronic mail index including its header by the full text search engine. In the indicating process of the individual electronic mails, the corresponding mail is extracted and shown from the individual electronic mail data by a CGI indicating process of the individual electronic mails.

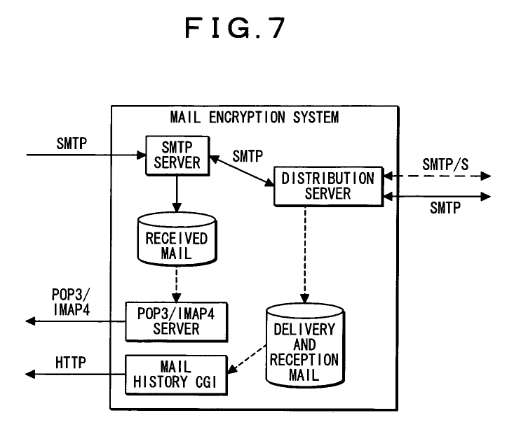

Next, FIG. 7 shows the construction of the hardware completed the mail encryption system in the present invention.

Since necessary functions are provided in the hardware the hardware shown in FIG. 7 to be connected to the sender clients and the receiver clients to send and receive electronic mails is only introduced, the electronic mail including its header can be encrypted when sending the electronic mail without installing an encryption system in the sender clients and the electronic mail including its header can be decrypted when receiving the electronic mail without installing an encryption system in the receiver client.

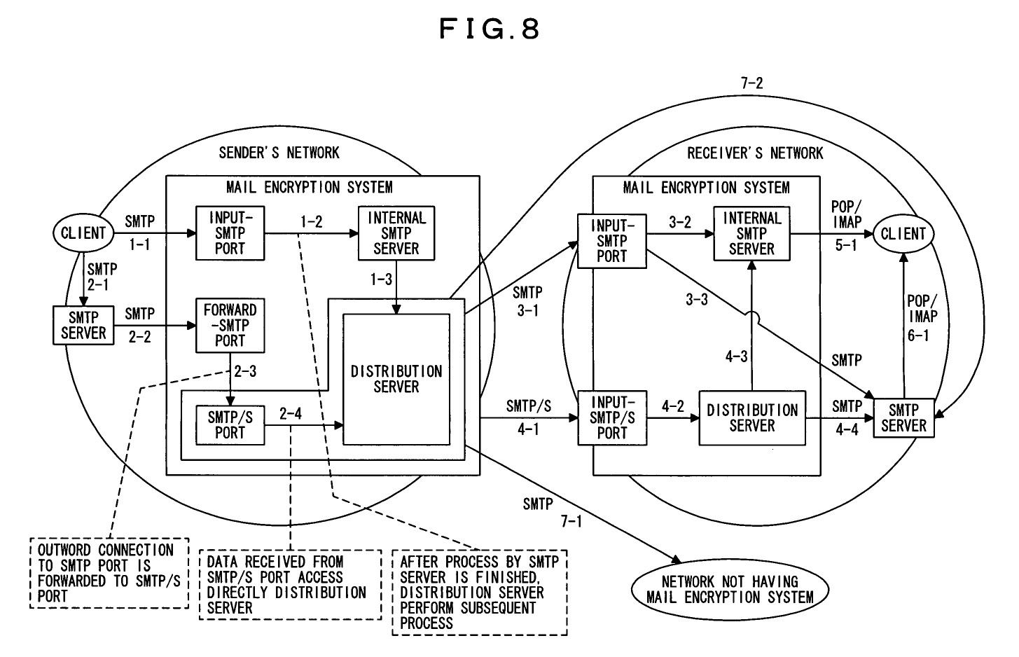

FIG. 8 is a flow of processes using the system in the present invention.

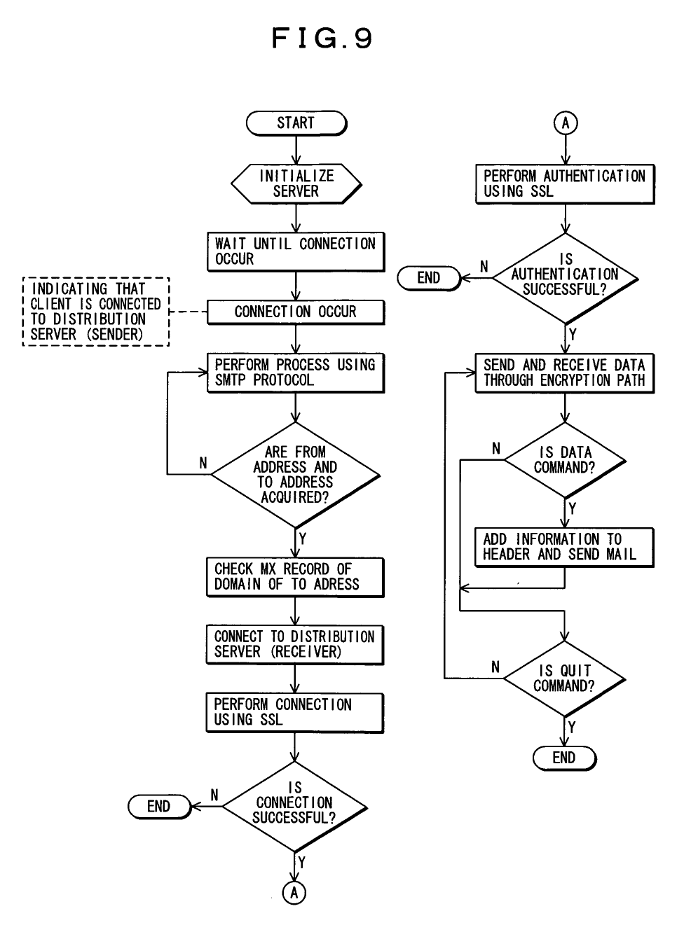

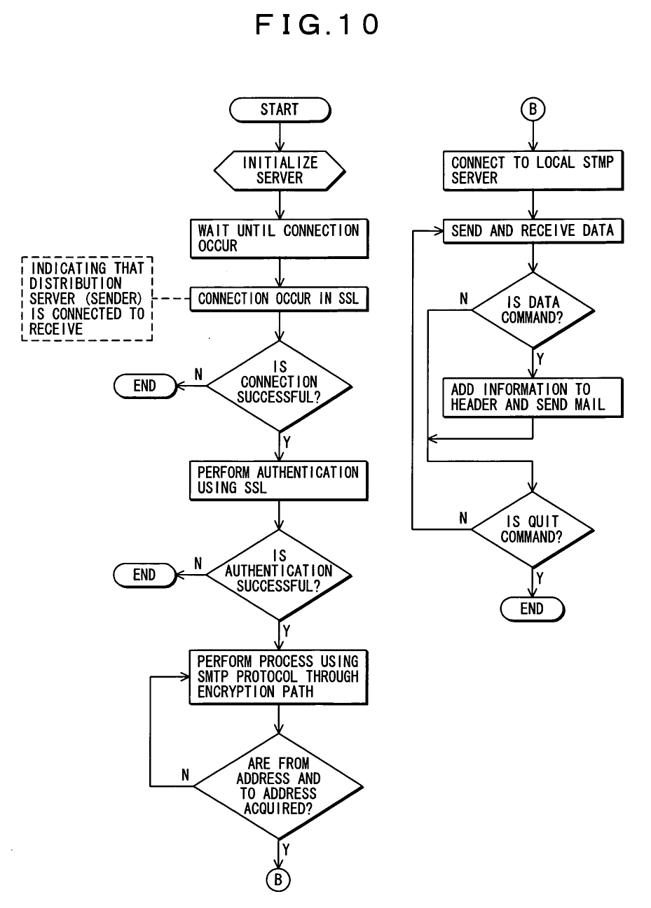

FIG. 9 is a flowchart of the basic processes in sender side and FIG. 10 is a flowchart of the basic processes in receiver side.

Referring to FIG. 8, the processes when an electronic mail is sent from the sender client to the SMTP server in the sender's mail encryption system will be described.

(1-1) The sender client accesses the SMTP port in the sender's mail encryption system.

(1-2) Data is sent to the inside SMTP server in the sender's mail encryption system in standby at the SMTP port.

(1-3) When the processes in the inside SMTP server in the sender's mail encryption system are finished, data is sent to the filtering server in the sender's mail encryption system.

Next, the processes when an electronic mail is sent from the sender client to another SMTP server in the sender's network will be described.

(2-1) The sender client sends an electronic mail to another SMTP server in the sender's network.

(2-2) Another sender's SMTP server in the network tries to access the SMTP port in the sender's mail encryption system.

(2-3) Data is forwarded to the SMTP/S port in the sender's mail encryption system Data by a port transfer function in the sender's mail encryption system.

(2-4) Data is sent to the filtering server in the sender's mail encryption system in standby at the SMTP/S port.

The filtering server checks the destination network of the electronic mail, determines whether the destination supports the electronic mail encryption system, and determines whether the authentication is successful.

Next, the processes when an electronic mail encryption system exists in the receiver's network but the establishment of the encryption path is failed will be described.

(3-1) Data is sent to the receiver's network through the SMTP port of the mail encryption system in the receiver's network from the filtering server in the sender's mail encryption system.

(3-2) When an SMTP server exists in the receiver's mail encryption system, data is sent to the inside SMTP server in the receiver's mail encryption system.

(3-3) When no SMTP server exists in the receiver's mail encryption system, data is sent to another SMTP server in the receiver's network.

Next, the processes when an electronic mail encryption system exists in the receiver's network and the establishment of the encryption path is succeeded will be described.

(4-1) Encryption data is sent to the SMTP/S port of the mail encryption system in the receiver's network from the filtering server in the sender's mail encryption system.

(4-2) Data is sent to the filtering server in the receiver's mail encryption system in standby at the SMTP/S port.

(4-3) When an SMTP server exists in the receiver's mail encryption system, data is sent to the SMTP server in the receiver's mail encryption system.

(4-4) When no SMTP server exists in the receiver's mail encryption system, data is sent to another SMTP server in the receiver's network.

Next, when the receiver client receives an electronic mail from the POP or IMAP server in the receiver's mail encryption system,

(5-1) Data is sent to the receiver client by the use of the POP3 or the IMAP4 in response to a request from the client in the receiver's network.

Next, when the receiver client receives an electronic mail from the POP or IMAP server outside the receiver's mail encryption system,

(6-1) Data is sent to the client in the receiver's network through the use of the POP3 or the IMAP4 in response to a request from the client in the receiver's network.

When no mail encryption system exists in the receiver's network,

(7-1) Data is sent to the SMTP server in the receiver's network from the filtering server in the sender's mail encryption system.

(7-2) When the receiver's mail encryption system does not operate due to any reason, data is sent to the SMTP server in the receiver's network.

### INDUSTRIAL APPLICABILITY

According to the present invention described above, it is possible to provide a system capable of simply introducing and distributing security measures, encrypting an electronic mail including its header when sending the electronic mail without installing an encryption system in sender clients, and decrypting the electronic mail including its header when receiving the electronic mail without installing an encryption system in receiver clients.

In addition, according to the present invention, it is possible to provide a system capable of functioning even when a destination of electronic mail does not support the decryption of this system or even when it is not clear whether the destination of electronic supports that decryption and of checking whether the destination supports an encrypted electronic mail.

Furthermore, according to the present invention, it is possible to provide a system not requiring an encryption method and not converting the domain name when sending an electronic mail and to provide the simple system without the maintenance in the table to manage destinations, and to provide hardware having all functions, therefore it is able to construct this system by only putting that hardware.

1. It is the system which is able to encrypt an electronic mail including its header when sending it without installing individually an encryption system in the sender's terminal and to decrypt the electronic mail including its header when receiving it without installing individually a decryption system in the receiver's terminal, composing sender clients, the sender's mail server, receiver clients, the receiver's mail server, and the networking between the sender clients and the receiver clients, wherein the sender's mail server includes: an SMTP server for receiving a plaintext electronic mail sent from the sender's terminal; destination check means in the electronic mail; as a result of them, this system call an SMTP/S protocol for encrypting and sending an electronic mail including its header when the destination of the electronic mail supports the SMTP/S protocol, and wherein the receiver's mail server includes: an SMTP server for receiving the electronic mail sent from the sender server and decryption means to decrypt the received electronic mail.

2. It is the system which is able to encrypt an electronic mail including its header when sending it without installing individually an encryption system in the sender's terminal composing sender clients and the sender's mail server, the system further comprising: destination check means in the electronic mail; as a result of them, this system call an SMTP/S protocol for encrypting and sending an electronic mail including its header when the destination of the electronic mail supports the SMTP/S protocol.

3. The electronic mail sending and receiving system according to claim 1, wherein the destination check means of the sender's mail server means a filtering server having a function of determining whether the receiver's mail server corresponds to the SMTP/S protocol.

4. The electronic mail sending and receiving system according to claim 3, wherein the determination of correspondence to the SMTP/S protocol results whether a handshake to an SMTP/S protocol port in the receiver's mail server is possible and includes whether the domain name in the receiver's mail server is ensured by an authentication center.

5. The electronic mail sending and receiving system according to claim 1, wherein the electronic mail encrypting and sending means in the sender's mail server sends, as a result of the destination check, a plaintext mail by the use of the SMTP protocol when the receiver's mail server dose not support the SMTP/S protocol.

6. The electronic mail sending and receiving system according to claim 1, wherein the SMTP server in the receiver's mail server stores the electronic mails sent by client in each receiver's mail box, when the destination of the electronic mail is in a local area.

7. The electronic mail sending and receiving system according to claim 1, wherein the SMTP server in the receiver's mail server is able to encrypt the path between the receiver's mail server and the receiver's mail client by receiving the electronic mails stored in the each mail box in the receiver mail client by the use of POP3/S and IMAP/S protocols.

8. The electronic mail sending and receiving system according to claim 1, wherein when the receiver's mail server sends the electronic mail to another mail server, the receiver's mail server includes: destination check means in the electronic mail which determine whether the destination supports the SMTP/S protocol or not and mail encrypting and sending means as a result of the destination check. When the destination supports the SMTP/S protocol, the electronic mails are encrypted and sent by it. When the destination does not support the SMTP/S protocol, the electronic mails are sent in plaintext by the SMTP protocol.

9. The electronic mail sending and receiving system according to claim 1, wherein the mail encrypting and sending means in the sender's mail server returns to the sender client the electronic mail indicating that the process is not successful including that data, when the electronic mail encryption by the use of the SMTP/S protocol is failed.

10. The electronic mail sending and receiving system according to claim 1, wherein the mail encrypting and sending means in the sender's mail server has a function of analyzing the data of the encryption process in the electronic mail header sent by the sender client.
